(19) United States
(12) Patent Application Publication
(10) Pub. No.: US 2004/0146762 A1
(43) Pub. Date: Jul. 29, 2004

(54) Reactant supply for a fuel cell power system

(75) Inventors: Todd A. Simpson, Brampton (CA); Joseph Cargnelli, Toronto (CA); Stephen Burany, Thornhill (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/722,577

(22) Filed: Nov. 28, 2003

Related U.S. Application Data
(60) Provisional application No. 60/429,323, filed on Nov. 27, 2002.

(51) Int. Cl. H01M 8/04

(52) U.S. Cl. 429/22; 429/23; 429/25; 429/13

(57) ABSTRACT

A fuel cell system, comprising: a fuel cell for producing electrical energy; a load driven by the fuel cell; a first reactant supply line for supplying a first reactant to the fuel cell; a second reactant supply line for supplying a second reactant to the fuel cell; a first reactant buffer for storing first reactant and supplying an additional amount of first reactant to the fuel cell in response to an increase in a measured characteristic; a first flow regulating device that regulating the amount of the first reactant supplied from the first reactant buffer to the fuel cell; and a controller for controlling the first flow regulating device in response to the measured characteristic.

### FIELD OF THE INVENTION

The present invention relates generally to a fuel cell power system and a method of operating a fuel cell power system. More particularly, the present invention relates to reactant supply for a fuel cell power system.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air, is introduced to the second electrode where the oxidant reacts electrochemically in the presence of the electrolyte and catalyst, producing anions and consuming the electrons circulated through the electrical circuit. The cations are also consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the two electrodes are, respectively, as follows:

H₂→2H++2e−

1/2O₂++2H++2e−→H₂O

The external electrical circuit withdraws electrical current and thus receives electrical power from the fuel cell. The overall fuel cell reaction produces electrical energy as shown by the sum of the separate half-cell reactions written above. Water and heat are typical by-products of the reaction.

In practice, fuel cells are not operated as single units. Rather, fuel cells are connected in series, stacked one on top of the other, or placed side by side, to form what is usually referred to as a fuel cell stack. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack. The stack and associated hardware make up a fuel cell module.

Nowadays, there is an increasing interest in using fuel cells in transport and like applications, e.g. as the basic power source for cars, buses and even larger vehicles. Automotive applications are quite different from many stationary applications. For example in stationary applications, fuel cell stacks are commonly used as an electrical power source and are simply expected to run at a relatively constant power level for an extended period of time. In contrast, in an automotive environment, the actual power required from the fuel cell stack can vary widely. Additionally, the fuel cell stack supply unit is expected to respond rapidly to sudden changes in power demand, whether these be demands for increased or reduced power, while maintaining high efficiencies. Further, for automotive applications, a fuel cell power unit is expected to operate under an extreme range of ambient temperature and humidity conditions. All of these requirements are exceedingly demanding and make it difficult to ensure a fuel cell stack will operate efficiently under all the possible range of operating conditions.

In order to respond rapidly to changes in power demand, a fuel cell needs to be supplied with appropriate amount of reactants such that it can deliver the desired power. In conventional systems, this is usually achieved by adjusting the operation of reactant supply devices, such as compressors, pumps, blowers, etc. However, this results in delay of response and the response itself may be inadequate. Furthermore, increasing the operating conditions of such reactant supply devices results in higher energy consumption by the device and hence higher parasitic load, which results in lower system efficiency.

Therefore, there remains a need for a fuel cell system that can offer rapid response to abrupt changes in load and power demand and provide high power output instantaneously, without compromising system efficiency.

### SUMMARY OF THE INVENTION

In accordance with a first object of the present invention, there is provided a fuel cell system, comprising: (a) a fuel cell; (b) a first reactant supply line for supplying a first reactant to the fuel cell; (c) a second reactant supply line for supplying a second reactant to the fuel cell; (d) a monitoring device for monitoring a measured characteristic; (e) a first reactant buffer for storing an additional supply of the first reactant; (e a first flow regulating device for regulating an additional amount of the first reactant supplied from the first reactant buffer to the fuel cell; and, (g) a controller for controlling the first flow regulating device in response to the measured characteristic.

In accordance with a second object of the present invention, there is provided a method of operating a fuel cell system. The method comprises: (a) supplying a first reactant to a fuel cell; (b) supplying a second reactant to the fuel cell; (c) supplying and storing an additional supply of the first reactant in a first reactant buffer; (d) measuring a measured characteristic; and (e) adjusting an additional amount of first reactant supplied to the fuel cell from the first reactant buffer in response to the measured characteristic.

### BRIEF DESCRIPTION OF THE DRAWINGS

For a better understanding of the present invention, and to show more clearly how it may be carried into effect, reference will now be made, by way of example, to the accompanying drawing, which shows a preferred embodiment of the present invention and in which:

FIG. 1 illustrates a schematic view of a fuel cell system in accordance with an embodiment of the present invention; and,

FIG. 2, in a block diagram, illustrates a controller of the fuel cell system of FIG. 1.

### DETAILED DESCRIPTION OF ASPECTS OF THE INVENTION

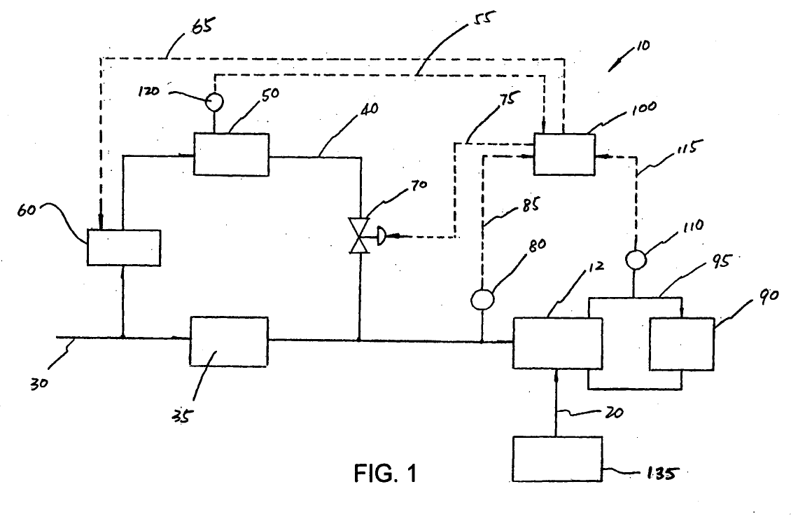

Referring first to FIG. 1, there is illustrated a schematic view of a fuel cell system 10 according to an embodiment of the present invention. The fuel cell system 10 comprises a fuel supply line 20, an oxidant supply line 30, both connected to a fuel cell 12. The fuel cell 12 drives a load 90 through an electrical circuit 95. It can be appreciated by those skilled in the art that depending on the operation mode and actual configuration of the fuel cell 12, it may or may not be provided with fuel and/or oxidant exhaust lines. In this particular example, no exhaust lines are shown. The fuel cell 12 may comprise a plurality of fuel cells or just a single fuel cell. For simplicity, the fuel cell 12 described herein operates on hydrogen as fuel and air as oxidant and can be a Proton Exchange Membrane (PEM) fuel cell. However, the present invention is not limited to this type of fuel cells and is applicable to other types of fuel cells.

An oxidant supply device, such as compressor or blower 35 is disposed in the oxidant supply line 30 for supplying oxidant, i.e. air, to the fuel cell 12. Similarly, a fuel supply device (not shown) can also be provided in the fuel supply line 20 for supplying fuel to the fuel cell 12. In FIG. 1, fuel, i.e. hydrogen is supplied from a hydrogen storage vessel 135, which is typically pressurized. A flow controller (not shown) can be provided in the fuel supply line 20 to regulate the flow or pressure of the hydrogen supplied to the fuel cell 12. In this case, a separate compressor or blower is not needed for the fuel supply line 20. A bypass line 40 is provided in the oxidant supply line 30, bypassing the oxidant supply device 35. A secondary oxidant supply device 60, for example, a compressor, is provided in the bypass line 40, which supplies the oxidant flowing along the bypass line 40 into a oxidant buffer vessel 50. Pressurized oxidant is stored in the oxidant buffer vessel 50. A flow regulating device, such as a solenoid valve 70, is provided in the bypass line 40 downstream of the oxidant buffer vessel 50 and controls the oxidant flow from the oxidant buffer vessel 50 back to the oxidant supply line 40. During normal operation, the valve 70 is closed to prevent oxidant flow from the oxidant buffer vessel 50.

When the power demand for the fuel cell 12 suddenly increases, the fuel cell 12 will demand (as described below) more reactants from the fuel and oxidant supply lines 20 and 30. In this case, the flow regulating device 70 opens to supply additional oxidant from the oxidant buffer vessel 50 to the oxidant supply line 30. This can be done instantaneously and hence the fuel cell system 10 is capable of rapid response to the abrupt change of power demand. The oxidant in the oxidant buffer vessel 50 is of higher pressure, for example, one order of magnitude higher pressure, than that in the oxidant supply line 30, in order to supplement the oxidant supply instantaneously.

The flow regulating device 70 can adjust the amount of additional oxidant supplied from the oxidant buffer vessel 50 to the oxidant supply line 30 by changing its opening extent. Preferably, the opening extent of the flow regulating device 70 changes in response to the pressure changes in the fuel cell 12 or in the oxidant supply line 30, or other characteristics in the fuel cell system 10 that can be monitored. For this purpose, a controller 100 is provided in the fuel cell system 10, which can be either a central controller that controls the operation of various fuel cell peripherals, such as compressors, pumps, etc, or a local controller that only controls the operation of the flow regulating device 70. The controller 100 reads monitored values representing the operating condition of the fuel cell 12 and controls the opening extent of the flow regulating device 70 accordingly.

In the fuel cell system 10 of FIG. 1, a pressure sensor 80 is provided in the oxidant supply line 30 adjacent the oxidant inlet of the fuel cell 12 and monitors the pressure at this point, which provides a good indication of the pressure at which the fuel cell 12 operates. The pressure sensor 80 is connected to controller 100 by line 85 and supplies a signal representing the monitored value of pressure to the controller 100 through line 85. The controller 100 in turn controls the operation of the flow regulating device 70 through control line 75. In stable operation, when the fuel cell 12 is operating under, for example 4 Psig, and the oxidant is supplied through oxidant supply line 30 under 4 Psig, the flow regulating device 70 is closed. When load or power demand changes, for example, increases, the fuel cell 12 starts to consume more oxidant. As a result, the pressure in the oxidant supply line 30 drops. In this case, the controller 100 controls the flow regulating device 70 to open to provide an additional supply of oxidant. The extent that the flow regulating device 70 opens can be controlled according to the pressure monitored by the pressure sensor 85. For example, when the pressure drops to 2 Psig, the flow regulating device 70 opens 20%, and when the pressure drops to near zero, the flow regulating device 70 opens 100%. This operation can be conducted dynamically so that the oxidant supply to the fuel cell is adequate for the power demand.

Another way to dynamically supplement oxidant to the fuel cell 12 from the oxidant buffer vessel 50 is to monitor the current drawn from the fuel cell 12 and to control the operation of the flow regulating device 70 accordingly. For this purpose, an ampere meter 110 is provided in the electrical circuit 95. The ampere meter 110 sends signals representing measured current values to the controller 100 through line 115. When the current the load 90 draws from the fuel cell 12 has changed beyond a certain level, the controller 100 controls the flow regulating device 70 to open to a selected extent. Similar to the above description, the extent that the flow regulating device 70 opens can be controlled by the controller 100 based on the current measured by the ampere meter 110. Alternatively, this operation can also be conducted dynamically. Specifically, after a stable operation condition has been established, as the ampere meter 110 senses current changes, the controller 100 controls the flow regulating device 70 to adjust the flow of the oxidant supply from the oxidant buffer vessel 50 accordingly, i.e. when the current increases, the flow regulating device 70 opens to a greater extent to allow more oxidant to be supplied to the fuel cell 12.

As mentioned above, the oxidant buffer vessel 50 contains pressurized oxidant, at, for example, 100 Psig. This oxidant is supplied to the buffer vessel 50 by a secondary oxidant supply device 60. For safety reasons, the supply of oxidant to the buffer vessel 50 needs to be stopped when the pressure inside the buffer vessel 50 reaches a certain level. This is done by providing a pressure sensor 120 to the buffer vessel 50. The pressure sensor 120 senses the pressure inside the buffer vessel 50 and sends a signal representing such pressure to the controller 100 through line 55. The controller in turn controls the operation of the secondary oxidant supply device 60 through control line 65 and stops the secondary supply device 60 when the pressure inside the buffer vessel 50 reaches a predetermined level. It is to be understood that the secondary oxidant supply device 60 may continue to operate while the oxidant inside of the oxidant buffer vessel 50 is being consumed. Alternatively, the secondary oxidant supply device 60 may only operate when the pressure inside the oxidant buffer vessel falls below a minimum pressure level. In other words, the replenishment of oxidant to the oxidant buffer vessel 50 can be done continuously or on a regular basis.

It is to be understood that the controller 100 can alternatively be a central controller or several local controllers specifically provided for various fuel cell peripherals, including the flow regulating device 70 and the secondary oxidant supply device 60. It is also to be understood that although not described, the buffer vessel, secondary supply device and flow regulating device can also be provided for the fuel of the fuel cell 12. In this case, the amount of both fuel and oxidant supplied to the fuel cell 12 can track the changes in power demand.

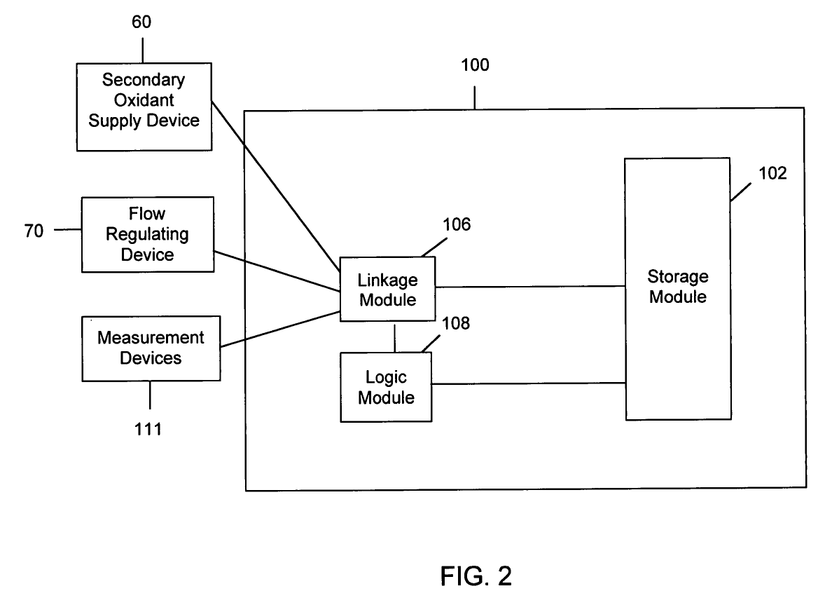

Referring to FIG. 2, there is illustrated in a block diagram, the controller 100 of FIG. 1. As shown, the controller 100 includes a linkage module 106 for linking the controller 100 to the flow regulating device 70 and possibly to other fuel cell peripherals (not shown) controlled by the controller 100. Linkage module 106 also connects controller 100 to measurement devices 111, such as pressure sensor 85 and amperemeter 110.

A storage module 102 containing controller 100 is linked to the linkage module 106 and stores fuel cell operation information. The fuel cell operation information would include information on the oxidant inflow required to meet certain loads, as well as the minimum pressure in the oxidant inflow being supplied to the fuel cell required to meet different power demands.

In operation, measurement devices 111 measure any changes in the current drawn from this fuel cell and in the pressure in the oxidant supply line. This information is communicated to the linkage module 106. Then, a logic module 108 compares this information regarding the current drawn from the fuel cell and the oxidant pressure with data stored in the storage module 102. If the oxidant pressure is lower than the minimum pressure indicated by the fuel cell operation information stored in the storage module 102, then logic module 108 determines how much additional oxidant is required to raise the oxidant pressure above the minimum pressure. Similarly, the logic module 108 checks any increase in the current drawn from the fuel cell with the fuel cell operating information stored in the storage module 102, to determine how much additional oxidant is required to meet the new load. Once the logic module 108 has determined how much additional oxidant is required to meet the new load, logic module 108 instructs flow regulating device 70 via linkage module 106 to open to a sufficient extent to permit sufficient additional oxidant from oxidant buffer vessel 50 to be supplied to the fuel cell.

Storage module 102 also stores maximum pressure constraints for oxidant buffer vessel 50. Measurement devices 111 also include pressure sensor 120, which supplies the linkage module 106 with the internal buffer pressure—that is, the pressure of the oxidant stored within buffer vessel 50. The logic module 108 then compares this internal buffer pressure with the maximum pressure for the buffer vessel 50 stored in the storage module 102. If the internal buffer pressure exceeds this maximum pressure, then logic module 108 instructs secondary oxidant supply device 60, via linkage module 106, to stop supplying oxidant to the buffer vessel 50. However, once the internal buffer pressure falls sufficiently below the maximum pressure, logic module 108 will again, via linkage module 106, instruct secondary oxidant supply 60 to again supply oxidant to the buffer vessel 50.

While the above description constitutes the preferred embodiments, it will be appreciated that the present invention is susceptible to modification and change without departing from the fair meaning of the proper scope of the accompanying claims. For example, the present invention might have applicability in various types of fuel cells, which include but are not limited to, solid oxide, alkaline, molton-carbonate, and phosphoric acid. In particular, the present invention may be applied to fuel cells which operate at much higher temperatures. As will be appreciated by those skilled in the art, the requirement for humidification is very dependent on the electrolyte used and also the temperature and pressure of operation of the fuel cell. Accordingly, it will be understood that the present invention may not be applicable to many types of fuel cells.

1. A fuel cell system, comprising:
a) a fuel cell;
b) a first reactant supply line for supplying a first reactant to the fuel cell;
c) a second reactant supply line for supplying a second reactant to the fuel cell;
d) a monitoring device for monitoring a measured characteristic;
e) a first reactant buffer for storing an additional supply of the first reactant;
f) a first flow regulating device for regulating an additional amount of the first reactant supplied from the first reactant buffer to the fuel cell; and
g) a controller for controlling the first flow regulating device in response to the measured characteristic.

2. A fuel cell system as claimed in claim 1, wherein the measured characteristic includes at least one of a first reactant pressure in the first reactant supply line and a current the load draws from the fuel cell.

3. A fuel cell system as claimed in claim 2, wherein the controller is operable to control the first flow regulating device to increase the amount of the first reactant supplied from the first reactant buffer in response to a change in the measured characteristic indicative of at least one of an increase in the current drawn from the fuel cell and a decrease in the first reactant pressure in the first reactant supply line.

4. A fuel cell system as claimed in claim 3, wherein the first reactant supply line is operable to supply the first reactant at a first reactant pressure, and the first reactant buffer is operable to store the first reactant at a substantially higher pressure than the first reactant pressure in the first reactant supply line.

5. A fuel cell system as claimed in claim 4, further comprising a first reactant primary supply device disposed in the first reactant supply line for supplying the first reactant to the fuel cell and a first reactant secondary supply device for supplying the first reactant to the first reactant buffer.

6. A fuel cell system as claimed in claim 5, wherein the first reactant secondary supply device, the first reactant buffer and the first flow regulating device are disposed in a bypass line that bypasses the first reactant primary supply device.

7. A fuel cell system as claimed in claim 6, further comprising a first pressure sensor disposed in the first reactant supply line immediately upstream of the fuel cell for measuring the first reactant pressure in the first reactant supply line and supplying a first signal representing the first reactant pressure to the controller.

8. A fuel cell system as claimed in claim 7, further comprising a current sensing device for sensing the current drawn from the fuel cell and supplying a second signal representing the current to the controller.

9. A fuel cell system as claimed in claim 8, further comprising a second pressure sensor for sensing a first reactant buffer pressure inside the first reactant buffer and supplying a third signal representing the first reactant buffer pressure to the controller.

10. A fuel cell system as claimed in claim 9, wherein the controller is operable to control the first reactant secondary supply device to stop supplying the first reactant to the first reactant buffer when the first reactant buffer pressure increases to a first predetermined level; and
actuate the first reactant secondary supply device to supply first reactant to the first reactant buffer when the first reactant buffer pressure falls to a second predetermined level lower than the first predetermined level.

11. A fuel cell system as claimed in claim 10, wherein the first reactant is an oxidant.

12. A fuel cell system as claimed in claim 1, further comprising
a second reactant buffer for storing an additional quantity of the second reactant;
a second flow regulating device for regulating an additional amount of the second reactant supplied from the second reactant buffer to the fuel cell; wherein the controller is operable to control the second flow regulating device in response to the measured characteristic.

13. A method of operating a fuel cell system, comprising:
a) supplying a first reactant to a fuel cell;
b) supplying a second reactant to the fuel cell;
c) supplying and storing an additional supply of the first reactant in a first reactant buffer;
d) measuring a measured characteristic; and
e) adjusting an additional amount of first reactant supplied to the fuel cell from the first reactant buffer in response to the measured characteristic.

14. A method of operating a fuel cell system as claimed in claim 13, wherein the measured characteristic includes at least one of a first reactant pressure in the first reactant supply line, and a current drawn from the fuel cell.

15. A method of operating a fuel cell system as claimed in claim 14, wherein step (e) comprises increasing the additional amount of the first reactant supplied from the first reactant buffer in response to at least one of a change in the measured characteristic indicative of at least one of an increase in the current drawn from the fuel cell and a decrease in the first reactant pressure in the first reactant supply line.

16. A method of operating a fuel cell system as claimed in claim 13, wherein step (c) comprises storing the first reactant at a higher pressure in the first reactant buffer than the first reactant pressure.

17. A method of operating a fuel cell system as claimed in claim 16, further comprising:
f) measuring a first reactant buffer pressure inside the first reactant buffer; and
g) supplying the first reactant to the first reactant buffer when the first reactant buffer pressure falls to a second predetermined level; and,
h) stopping supply of the first reactant to the first reactant buffer when the first reactant buffer pressure increases to a first predetermined level higher than the second predetermined level.

18. A method of operating a fuel cell system as claimed in claim 13 wherein the first reactant is an oxidant.
